(19) United States
(12) Patent Application Publication
(10) Pub. No.: US 2026/0187140 A1
(43) Pub. Date: Jul. 2, 2026

(54) TRANSFORMER-AIDED SEMANTIC MEANING EXTRACTION FROM MULTIMODAL DATA

(71) Applicant: NEC Laboratories America, Inc., Princeton, NJ (US)

(72) Inventors: Mohammad Khojastepour, Lawrenceville, NJ (US); Matin Mortaheb, College Park, MD (US)

(21) Appl. No.: 19/400,169

(22) Filed: Nov. 25, 2025

Related U.S. Application Data
(60) Provisional application No. 63/725,572, filed on Nov. 27, 2024.
(60) Provisional application No. 63/842,120, filed on Jul. 11, 2025.

(51) Int. Cl. G06F 16/535; G06F 16/51; G06T 3/40

(52) U.S. Cl. CPC G06F 16/535; G06F 16/51; G06T 3/40

(57) ABSTRACT

Systems and methods for adaptive transformer aided-semantic communication with multi-resolution encoding. The systems and methods include encoding patches of an image by flattening the patches to one-dimensional (1D) vectors to form encoded patches and determining an attention score of each of the patches using a vision transformer (ViT) and determining a semantic relevance of each of the patches to a user query using the respective attention score. The systems and methods further include adaptively transmitting the encoded patches with different resolutions based upon an amount of the semantic relevance.

### RELATED APPLICATION INFORMATION

This application claims priority to U.S. Provisional Patent Application No. 63/725,572, filed on Nov. 27, 2024, and U.S. Provisional Patent Application No. 63/842,120, filed on Jul. 11, 2025, incorporated herein by reference in their entirety.

### BACKGROUND

### Technical Field

The present invention relates to information encoding and more particularly applying a multi-resolution encoding mask to categorize the importance of different aspects of the same multi-modal data.

### Description of the Related Art

Multi-modal encoding systems apply end-to-end communication systems to achieve semantic communication. These systems focus on reconstructing data at a receiver, while ensuring retention of semantic information during the encoding process (known as goal-oriented communication). This style of encoding preserves the data, without considering the importance of different portions of the data and other considerations.

Goal-oriented communication has several problems. These include limitations inability to adapt to fluctuating bandwidth conditions due to encoder size being static, and difficulty identifying and indicating relevant segments of the original data since it is difficult to encode an entire dataset into a fixed-size format.

### SUMMARY

According to an aspect of the present invention, a method is provided for adaptive transformer-aided semantic communication with multi-resolution encoding. The method includes encoding patches of an image by flattening the patches to one-dimensional (1D) vectors to form encoded patches and determining an attention score of each of the patches using a vision transformer (ViT) and determining a semantic relevance of each of the patches to a user query using the respective attention score. The method further includes adaptively transmitting the encoded patches with different resolutions based upon an amount of the semantic relevance.

According to another aspect of the present invention, a system is provided for adaptive transformer-aided semantic communication with multi-resolution encoding. The system includes a processor and a memory storing computer-readable instructions. The memory causes the processor to encode patches of an image by flattening the patches to 1D vectors to form encoded patches and determine an attention score of each of the patches using a ViT and determine a semantic relevance of each of the patches to a user query using the respective attention score. The memory further causes the processor to adaptively transmit the encoded patches with different resolutions based upon an amount of the semantic relevance.

According to yet another aspect of the present invention, a computer program product comprising a non-transitory computer-readable storage medium containing computer program code, the computer program code when executed by one or more processors causes the one or more processors to perform operations. The operations including, causing the processors to encode patches of an image by flattening the patches to 1D vectors to form encoded patches and determine an attention score of each of the patches using a ViT and determine a semantic relevance of each of the patches to a user query using the respective attention score. The operations also include adaptively transmit the encoded patches with different resolutions based upon an amount of the semantic relevance.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram illustrating a high-level schematic for identifying and transmitting semantically relevant information, in accordance with an embodiment of the present invention;

FIG. 2 is a block diagram illustrating a system for transmitting an image with adaptive multi-resolution encoding, in accordance with an embodiment of the present invention;

FIG. 3 is a block diagram illustrating a vision transformer, in accordance with an embodiment of the present invention;

FIG. 4 is a block diagram illustrating attention heads, in accordance with an embodiment of the present invention;

FIG. 5 is a block/flow diagram illustrating a data pipeline for multi-resolution image transmission, in accordance with an embodiment of the present invention;

FIGS. 6-7 are pseudocode for training a multi-resolution adaptive image transmission framework, in accordance with an embodiment of the present invention;

FIGS. 8-9 are pseudocode for implementing an attention-guided resolution selector algorithm, in accordance with an embodiment of the present invention.

FIG. 10 is pseudocode for implementing lower quantization and upper quantization, in accordance with an embodiment of the present invention;

FIG. 11 is a block/flow diagram illustrating a method for performing a multi-resolution adaptive image transmission framework, in accordance with an embodiment of the present invention; and

FIG. 12 is a block diagram is shown for an exemplary processing system for implementing a multi-resolution adaptive image transmission framework, in accordance with an embodiment of the present invention.

### DETAILED DESCRIPTION OF PREFERRED EMBODIMENTS

As 6th Generation (6G) communication systems develop, semantic communication is becoming more prevalent. Semantic communication prioritizes the meaning and purpose behind the transmitted data, not just the accuracy of the transmission. This difference prioritizes the transmission of more relevant aspects of data (e.g., at a higher resolution). This useful for supporting next generation services, such as such as, e.g., holographic telepresence, haptic feedback at remote sites, improved streaming quality, brain-machine interfaces, full-sensory streaming, extended reality, etc., where reconstructing data is useful but transmitted content fulfills a specific objective in real-time, often with bandwidth and latency constraints. Embodiments of the present invention analyze data semantically and parse out relevant information and irrelevant information, to optimize for bandwidth and other constraints.

In embodiments of the present invention, relevant parts of the data are transmitted with higher fidelity than less relevant or irrelevant aspects. The relevance can be determined by a class label or the query given by a user, though other means of determining relevance are also contemplated.

Embodiments of the present invention address challenges posed by fading channels and varying channel capacities by applying separate source and channel coding. Due to fading channels, channel rates vary over time. So, for each block of data transmission, the source encoding rate can be adapted to the available channel rate and transmitted based on the semantic importance of the data being transmitted. This real-time, adaptive transmission process ensures that the reconstructed data at the receiver maintains high fidelity in the most relevant regions, while less relevant areas can be represented with lower resolution or even left blank. Relevant data can be considered important, useful, contextually significant data, information-rich data, meaningful data, high-value data, etc.

At the receiver side, parsed data (image patches) are decoded according to their received resolution, allowing the system to retain the relevant content even under fluctuating bandwidth conditions.

By optimizing which data is transmitted at varying resolutions based on semantic importance, channel constraints can be dynamically adhered to, which can achieve better overall transmission performance (as compared to conventional methods).

Embodiments of the present invention utilize a macroblock-wise quantization method that allows the original data to be encoded at the macroblock level, tailored to a significance. The significance is determined by an analysis of the receiver (e.g., the receiver's transmission capabilities). In this embodiment, the significance (importance) can be related to the bitrate allocated for each segment or macroblock for conveying the asserted goal and in the view of the total available bandwidth for transmission of the data. This can utilize advanced deep learning modules which are capable of deciding the optimal encoding quality for each macroblock.

Transformers are employed in embodiments of the present invention for encoding since they leverage the interconnections within different sections of the input. The effectiveness of transformers is related to the associated attention units they include, which assign attention scores to various parts of the input, correlating the relevance to the intended task.

Embodiments of the present invention can be represented in terms of visual and textual data, however, any combination of visual/image, audio, video, textual, structured/tabular, programming code, sensor, document level data, etc., are also contemplated. For example, holographic telepresence data can be transmitted. Similarly, haptic/tactile communication be transmitted through the use of embodiments of the present invention.

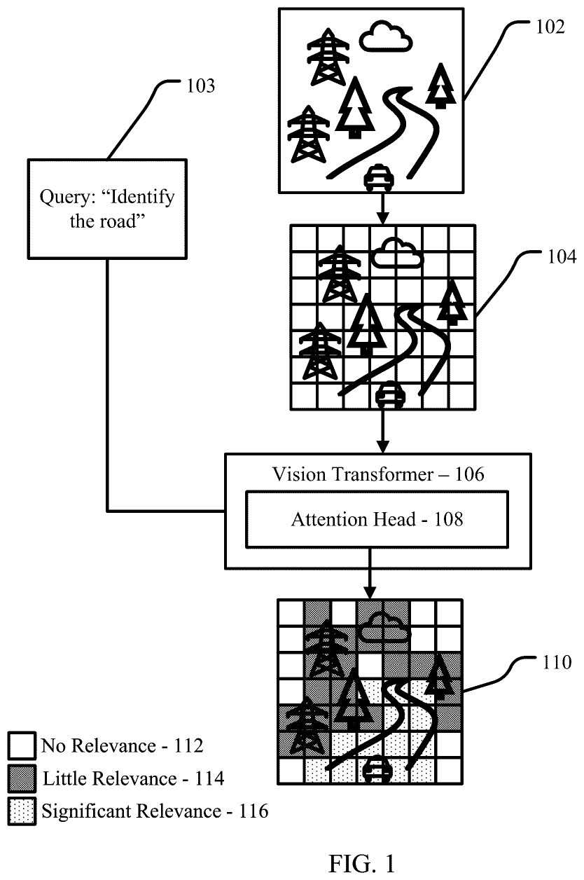

Referring now in detail to the figures in which like numerals represent the same or similar elements and initially to FIG. 1, a high-level schematic diagram for identifying and transmitting semantically relevant information, is illustratively depicted in accordance with one embodiment of the present invention. A vision transformer 106 (ViT) can receive image 102 and textual data 103, which can identify the portion of the data (image 102) that has semantic relevance. Some aspects of the present invention consider complex data (e.g., images depicting scenes containing multiple objects or ambiguous context) and tasks by leveraging cross-modal attention between image 102 and user-provided textual query 103 (or between patches 104 or images 102 compared to each other). This enables user-guided selection of important regions which refines the content to better align with the user intent. Selecting important regions can be performed by employing pre-trained vision-language models like contrastive language-image pre-training (CLIP).

Attention scores can be assigned to each image patch 104 to quantify the importance of patch 104. Patches 104 can be of a fixed size or variable size. Patches 104 can be regular shapes such as squares, triangles, hexagons, etc., or irregular shapes and unevenly sized. In embodiments of the present invention that employ irregular patch sizes, a two-dimensional mapping that maps irregular sizes into a uniform patch format can be present.

These scores act as a proxy for how useful each patch 104 is to the intended task. Using this proxy, a binary attention mask is generated to select a subset of patches 104 that are most informative. These patches 104 are transmitted. In some embodiments of the present invention, all patches 104 are transmitted, none are, or some are, depending on the semantic relevance of each patch 104. In even further embodiments the transmission of patches 104 can be at multiple resolutions based on the semantic relevance.

The attention score can be assigned by attention head 108. An attention score ensures that even under stringent bandwidth constraints, the most relevant semantic content of an image can be preserved, while less relevant patches can be discarded. Applying attention scores to pass embeddings from one layer to the next can reduce the computational overhead during transformer model fine-tuning.

A transmitted image 110 can include patches 104 of significant relevance 116, and some or all patches 104 classified as little relevance 114, while omitting patches 104 of no relevance 112 (or transfer patches 104 of no relevance with minimal resolution). Patches 104 of little relevance 114 can have a lower resolution or be transmitted at a lower rate (e.g., bitrate) than patches 104 of significant relevance. In other words, little relevance 114 can be prioritized higher than no relevance 112, and lower than significant relevance 116. Alternatively, if there are not enough patches 104 of significant relevance 116, some patches 104 of little relevance 114 can be transmitted at a higher resolution than other patches 104 of little relevance 114. This higher resolution can be the same resolution as patches 104 of significant relevance 116, or an intermediate resolution. There can be discreet resolution steps or a continuum of resolutions based on a variety of factors such as computing power, bitrate and channel constraints, user preference, etc.

Attention head 108 evaluates relationships, both among patches 104 themselves and between each patch 104 and the specific task the transformer is trained to perform (e.g., the task described within query 103). Artificial intelligence (AI) models such as, e.g., a large language model (LLM) or multi-modal LLM (MLLM), Vision Language Models (VLMs), and others are contemplated to be incorporated where applicable to add functionality to the multi-resolution encoding-transmission-decoding framework. These functionalities can include understanding the task from query 103 and integrating with ViT 106, or performing planner operations.

In classification tasks, attention head 108 can assess the interdependency among patches 104 during training. Additionally, attention head 108 can evaluate the contribution of each patch 104 towards accurately predicting image 102 class, thereby determining the relevance of each segment in achieving the objective of query 103. Based on the relevance, downstream tasks can be adapted such as transmission of selected patches 104. Query 103 can be audio, code, or other forms of input aside from natural language in alternative embodiments of the present invention.

A subset of patches 104 can be selected, and similar (or the same) rates for transmitting each of the selected patches 104 can be used. The selected patches 104 (little relevance 114 or significant relevance 116) correspond to the section of input image 102 which includes more relevant information to the semantic content, e.g., the pieces of the road or near the road in FIG. 1, where the semantic content is the class “road.” These selected portions are then transmitted to the receiver and then decoded. The decoding can reconstruct the image (or other types of data).

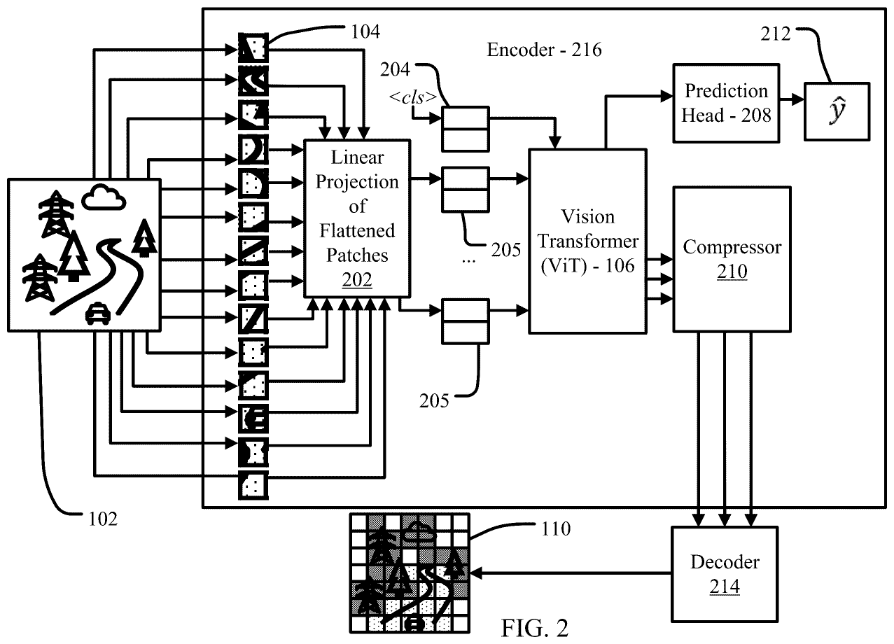

Referring to FIG. 2, a block diagram illustrating the pipeline for transmitting an image with adaptive multi-resolution encoding is illustratively depicted. The pipeline includes encoder 216, decoder 214, and classifier (prediction head) 208. Encoder 216 includes several blocks such as a projector, including linear projection of flattened patches 202, ViT 106, and compressor 210.

Encoder 216 receives image 102. Image 102 can be defined as [symbol] ϵ [symbol] ^{(3,h,w)}, where h and w denote the image's height and width and 3 is the number of image channels, e.g., red, green, blue (RGB) colors, though other numbers of image channels and configurations of channels are also contemplated. Each image 102 is divided into sequences of patches 104 according to Xᵢ, ∀iϵ[P], where each patch 104 is of size p×p, resulting in

$$P = \frac{hw}{{p}^{2}}$$

patches 104 per image 102. One-dimensional indexing (1D index) is used for the position of the patches by numbering the patches 104 sequentially. Each patch 104 is flattened to a vector X̅ϵ [symbol] ^{(3p}^{²}^{,1)} which is in turn transformed into vectors \acute{X}ᵢ of dimension D via Wₚᵣₒⱼϵ [symbol] ^{(D,3p}^{²}⁾. The transformation is analogous to tokenization in natural language processing (NLP) tasks. Each patch 104 is mapped by linear projection of flattened patches 202 using a linear layer to an embedding of size d that is matched with ViT 106 embedding size.

Then, ViT 106 receives the patches 104 and determines the relevance of each patch. ViT 106 receives embeddings 205 that represent patches 202. Additionally, classification (<cls>) 204 (also known as class label 204), which is the same size, is also appended with embeddings 205 and is trained and used for classification purposes. Once ViT 106 is trained for the specific task, a last transformer block in an attention matrix formed in ViT 106 can find the relevancy of each patch 104 to class label 204.

For each image 102, ViT 106 forms a matrix \tilde{X}=[\tilde{X}_{cls}, \tilde{X}₁, . . . , \tilde{X}_{P}]ϵ [symbol] ^{(D,P+1)} which includes a random vector \tilde{X}_{cls} and sequence of P vectors \tilde{X}ᵢ for each patch 104 in sequence, where vector \tilde{X}ᵢ is the superposition of vector \tilde{X}ᵢ with the positional encoding vectors. After passing through ViT 106, the transformation of the vector \tilde{X}_{cls} can hold the information for classification of image 102.

The matrix \tilde{X} is then processed through several transformer layers sequentially, each has a multi-head attention (MHA) and a multi-layer perceptron (MLP) layer ƒ_{MLP} with a non-linear activation function. The output of the last transformer layer z=[z_{cls}, z₁, . . . , z_{P}]ϵ [symbol] ^{(D,P+1)} includes z_{cls} which is the transformation of \tilde{X}_{cls} used for classification, followed by P vectors zᵢ that include the encoded data for each patch 104.

For simplicity of the notation, the indexing of the layers is dropped herein and explained in a generic layer.

Each transformer layer in ViT 106 includes H parallel attention heads which score the attention of each patch 104. Matrix \tilde{X} is formed with H vertically partitioned matrices, e.g., \tilde{X}=[\tilde{X}₁, . . . , \tilde{X}_{H}]^{T} where

$${\tilde{X}}_{h} ∈ {ℝ}^{( \frac{D}{H} , P + 1 )} ,$$

∀hϵ[H] is the input for the head.

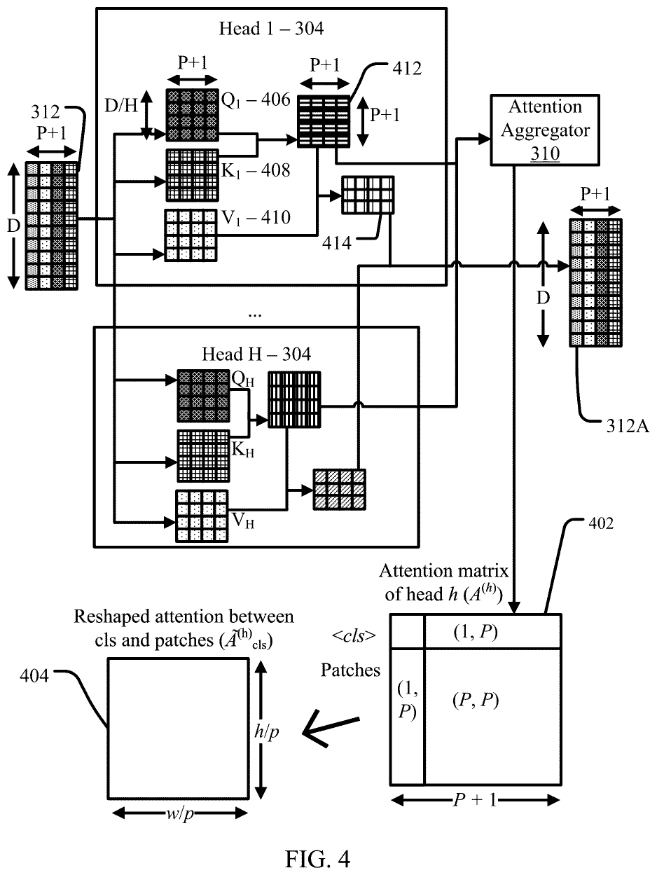

Query Q^{(h)}, key K^{(h)}, and value V^{(h)} (FIG. 4) are matrices formed within ViT 106 with dimensions of D/H×(P+1), which are produced by using the trainable set of weight matrices

$${W}_{Q}^{( h )} ,$$

$${W}_{K}^{( h )} ,$$

$$and {W}_{V}^{( h )} ,$$

of size D/H by D/H, respectively. Query Q^{(h)} transforms the input to a format that is then compared with key K^{(h)}, and the result of this comparison is linearly combined through value V^{(h)}.

For each head, an attention score matrix A^{(h)}(Q, K)ϵ [symbol] ^{(P+1,P+1)} is calculated as,

$${A}^{( h )} ( Q , K ) = softmax ( \frac{{Q}^{( h )} {K}^{{( h )}^{T}}}{\sqrt{D}} ) .$$

The output for the head is obtained by a linear transformation of the value matrix through attention scores. The output from each attention head O^{(h)} is concatenated to form the output of MHA, represented as O=[O⁽¹⁾, . . . , O^{(H)}]ϵ [symbol] ^{(D,P+1)} The output is then fed into the MLP with transfer function ƒ_{MLP}(O, φₘₗₚ) to produce the output for the transformer layer, where φₘₗₚ are MLP parameters. In embodiments of the present invention, each layer has its own parameters that are learned in the training phase.

ViT 106 predicts the input image class 212 ŷ by processing z_{cls} through a single-layer neural network ƒ_{predictor}, e.g., ŷ=ƒ_{predictor}(z_{cls}, φ_{pred}), where φ_{pred} is the parameters of prediction head 208. ŷ can be used in the training to train <cls> 204. ViT 106 can be trained using supervised training by jointly training the projector, ViT 106, and prediction head 208 ƒ_{predictor}.

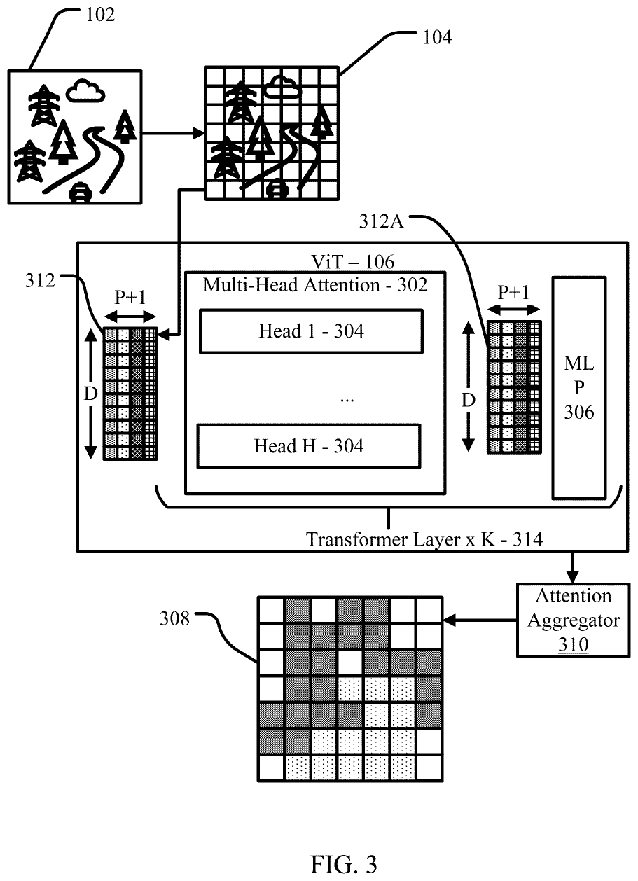

FIGS. 3-4 illustrate ViT 106 in greater detail.

Compressor 210 can prepare (compress) transmission packets based on the output from ViT 106 and internal states. Also, compressor 210 can adapt to varying packet bitrates to match the instantaneous channel capacity, assuming that the channel is error-free and has limited capacity which can fluctuate over time. The received packets are re-arranged in a proper format and passed to decoder 214, which reconstructs image 102 to form transmitted image 110. The classifier (prediction head 208) processes the transmitted image 110 to predict the class 212 ŷ.

Compressor 210 uses a design parameter αϵ[0,1] to find a threshold A such that by selecting patches 104 with higher scores than λ, the cumulative bitrate of the transmitted patches 104 is maximized but does not exceed α portion of the bitrate constraint. Compressor 210 can also select additional random patches 104 from the remaining patches 104 to maximize the transmission rate without exceeding the bitrate constraint. As a result, the transmitted packet \hat{z} includes the encoded data for the selected patches 104, and a positional mask Mϵ [symbol] ^{(w/p,h/p)} which indicates which patches 104 are selected. In embodiments of the present invention, the bitrate required for the positional mask can be ignored, as the bitrate can be negligible in comparison to the packet bitrate.

Once complete, compressor 210 can assess whether each patch 104 meets an attention score threshold and can either be transmitted or not. If patch 104 can be transmitted, compressor can evaluate whether to transmit patch 104 at full resolution or a lesser resolution. The attention scores between <cls> 204 and each patch 104, extracted from the final transformer layer, serve as indicators of semantic relevance.

Patches 104 that are transmitted, are input to decoder 214 to reconstruct image 102 to form transmitted image 110. Additionally, ViT 106 passes on information to prediction head (classifier) 208 to form input image class 212. Prediction head 208 can also be known as analytic action head. Prediction head 208 can replace a classifier 208 that directly works on image 102.

Decoder 214 ƒ_{decoder}(\hat{z}, θ) is designed to reconstruct image 102 by minimizing the loss function [symbol] _{decoder}=∥(M⊗B)⊚(X−\hat{X})∥². The loss function trains the parameters θ to minimize the mean squared error (MSE) for the selected patches 104 in the positional mask M, where B is a matrix of size p×p, ⊚ is the Hadamard product, and ⊗ is the Kronecker product. Other loss functions are also contemplated.

The loss function can maximize the reconstruction performance of different parts of image 102 proportional to their semantic information. This assigns an optimal resolution level based on the semantic significance of each patch 104 and the instantaneous channel conditions and enables the encoder 216 to make efficient use of bandwidth while preserving the most meaningful visual information.

Embodiments of the present invention assign appropriate resolutions for each patch 104 of image 102 to be encoded with varying rates, depending on their semantic content and available channel rate.

Referring to FIGS. 3-4, ViT 106 is shown in greater detail. During the training phase, cross-entropy loss [symbol] _{CE}(ŷ, c) can employed between the true class label 204 and predicted class 212 (FIG. 2) to jointly train the projector, transformer, and classifier 208 (FIG. 2).

ViT 106 can develop attention score matrices 402 {A^{(h)}, hϵ[H]} in the last transformer layer to include information about the semantic content of patches 104, which helps the model decide which patches 104 are semantically relevant. The input to ViT 106 is input head matrix 312 \tilde{X} of dimensions D×P+1 which represents image 102.

Attention score matrices 402 are formed in each head 304 of MHA 302 and processed in MLP 306 of each transformer layer 314 to determine the attention of each patch 104 in matrix \tilde{X}. The attention score matrices 402 are aggregated in attention aggregator 310 which forms the attention score matrix (e.g., multi-resolution map 308 or a binary mask).

The first row of attention matrix 402 is denoted by

$${A}_{c l s}^{( h )} = {A}^{( h )} [ 0 , ∶ ] ,$$

hϵ[H] and is a measure of the relevancy of patches 104 to the semantic content of input image 102. The value of the score in position i in vector

$${A}_{c l s}^{( h )}$$

highlights the significance of each patch 104 with 1D index i for classification.

$${A}_{c l s}^{( h )}$$

can be reshaped into a square matrix 404 of size (w/p, h/p) to form

$${A}_{c l s}^{( h )}$$

by using the relationship between the two-dimensional position and 1D index of patches 104. In order to combine the information from all heads in ViT 106, the average of

$${A}_{c l s}^{( h )}$$

for all hϵ[H] heads 304 denoted as A_{cls} is determined (using attention aggregator 310).

Within heads 304 several other matrices are formed, query matrix 406 Qᵢ, key matrix 408 Kᵢ, and value matrix 410 Vᵢ. Value matrix 410 is processed through a linear transformation to output attention scores. Query matrix 406 and key matrix 408 are processed to form attention matrix 412. Attention matrix 412 of heads 304 are combined in attention aggregator 310 to form average attention score matrix 402 (and subsequently multi-resolution map 308 or binary mask). Value matrix 410 and attention matrix 412 are then combined into matrix 414 of size P+1×D/H. Matrix 414 from heads 304 are combined to form head matrix 312A. Head matrix 312A is then applied to MLP 306 for each transformer layer 314.

In some embodiments of the present invention the attention score derived from heads 304 can then be used to form a binary mask, allowing patches 104 that positively affect the classification to be transmitted as marked by one (1) as opposed to zero (0) for the patched that are not transmitted. Whether patch 104 positively affects the classification can be determined by a threshold in some embodiments of the present invention. Compressor 210 (FIG. 2) can determine the effect of the classification in some embodiments of the present invention.

Other embodiments of the present invention employ a multi-resolution mask instead of a binary mask. The figures depict a multi-resolution mask; however, features can be applied interchangeably between the embodiments without limitation.

In an embodiment of the present invention including a multi-resolution mask, the first row of the attention matrix can be vector of length 1+P, where the last P values of the vector correspond to the cross attention between <cls> 204 (FIG. 2) and each patch 104. The higher the attention value, the higher the importance of the corresponding patch for the desired analytic action. Using the attention matrix for all the heads in the last transformer block, a multi-resolution map 308 of size (w/p)×(h/p) can be generated to determine the appropriate encoding level for each patch 104.

Attention mask 404 of size

$$\frac{w}{p} \times \frac{h}{p}$$

can be generated based on the first row of the attention matrix 402 for each head 304 in the last transformer block, which is a measure of relevancy. Then, the average attention mask for all heads 304 is found in attention aggregator 310. After, the average attention mask 404 is quantized to obtain the multi-resolution map 308. This optimizes the resolution into appropriate quantization levels that minimizes the quantization error under several constraints so that the encoding rate for the multi-resolution map 308 can avoid exceeding the available channel rate and the number of patches 104 that are assigned a nonzero-bitrate is maximized.

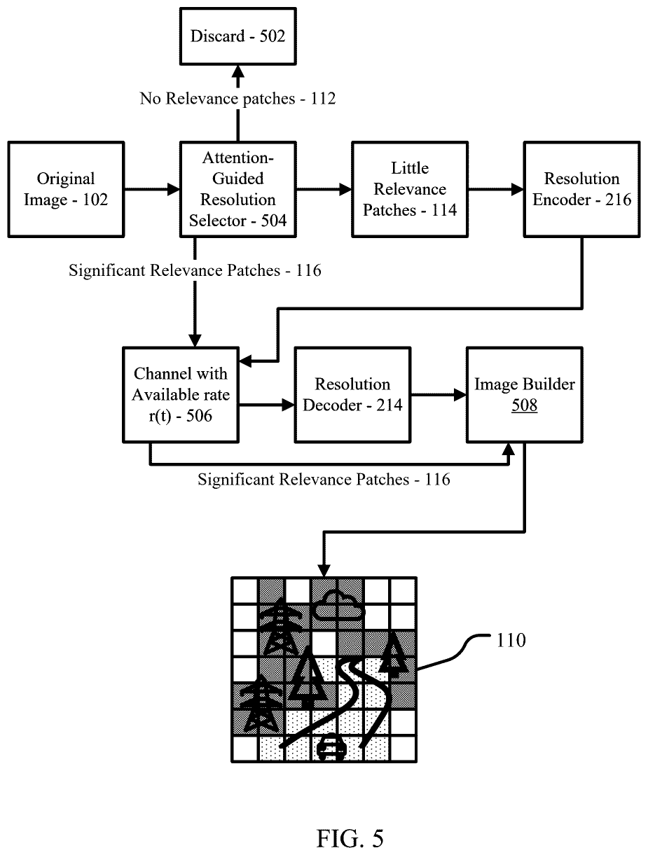

Referring to FIG. 5, a flow diagram illustrating the data pipeline for multi-resolution image transmission is depicted. Original image 102 is input into attention guided resolution selector 504. The resolution selector parses original image 102 and determines whether the parsed image sections have no relevance 112, little relevance 114, or significant relevance 116. Patches that have no relevance 112 are discarded 502 and are not used in the future (e.g., discarded). Patches of little relevance 114 are sent to the resolution encoder 216 which determines the amount of semantic relevance, and some patches 104 can be used in the future.

Attention guided resolution selector 504 can use attention scores or masks derived from attention scores (e.g., multi-resolution map 308 (FIG. 3)) to determine/identify/categorize the semantic relevance of each patch 104 (FIG. 1). The criteria for semantic relevance can be adaptive in multiple ways such as location on the image, e.g., where peripheral portions have a higher (or lower) threshold than portions towards the center of the image. Alternatively semantic relevance can be determined by proximity to specific objects, e.g., objects near a dumpster are less (or more important). Additional methods for adapting the threshold and consequently adapting semantic relevance are also contemplated.

Resolution encoder 216 encodes little relevance patches 114. In some embodiments of the present invention, significant relevance 116 is not encoded, while in others there is encoding, and in even further embodiments there is minimal encoding to ensure against noise/interference, attenuation, timing distortions, etc. Then the little relevance patches 114 along with significant relevance patches 116 are transmitted using channel with available rate 506. Here the adaptive channels are transmitting data. The transmitted data is received by resolution decoder 214. The decoded data is then sent to image builder 508 along with significant relevance patches 116 to form a transmitted image. The result of image builder 508 is transmitted image 110. Significant relevance 116 is retained throughout the transmission while the remainer of image 102 is evaluated for whether the portions of the data can be transmitted based on their importance.

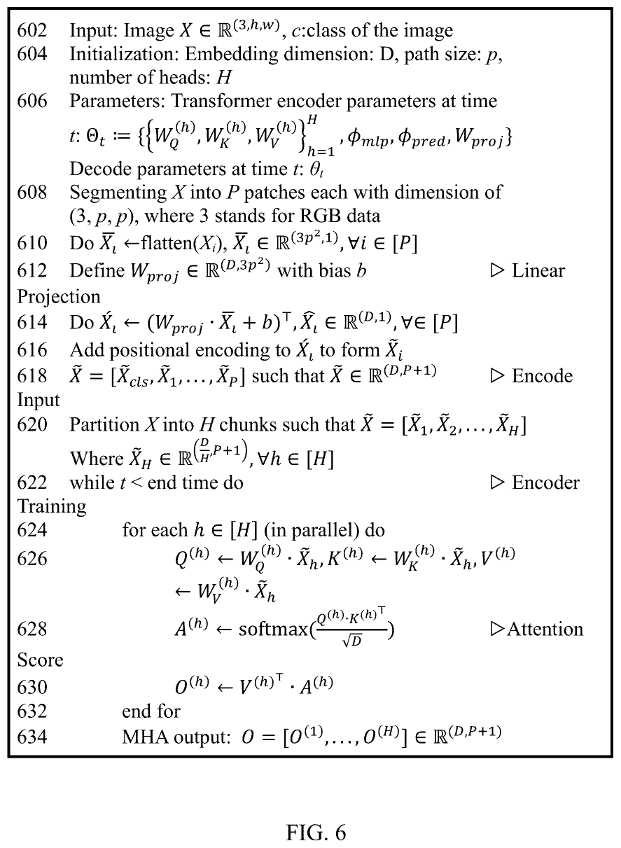

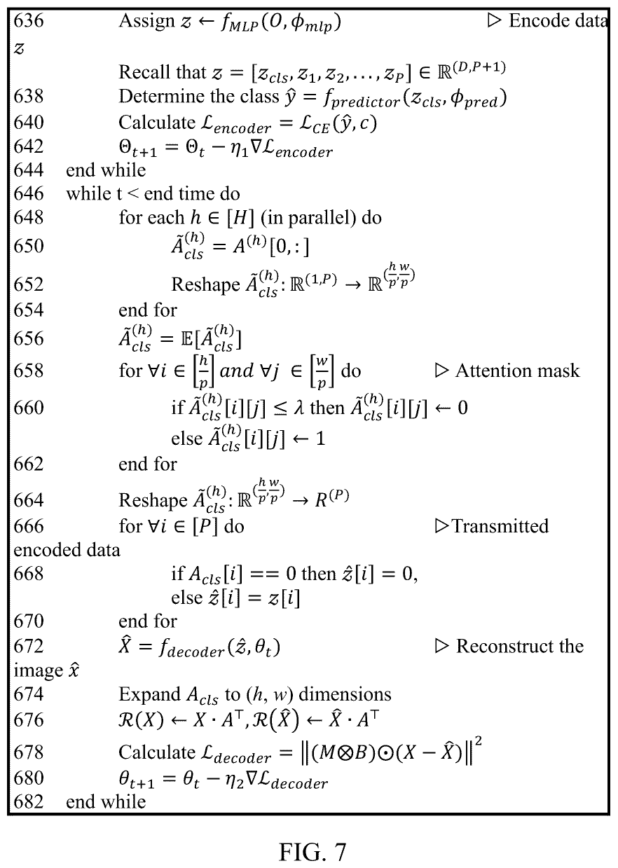

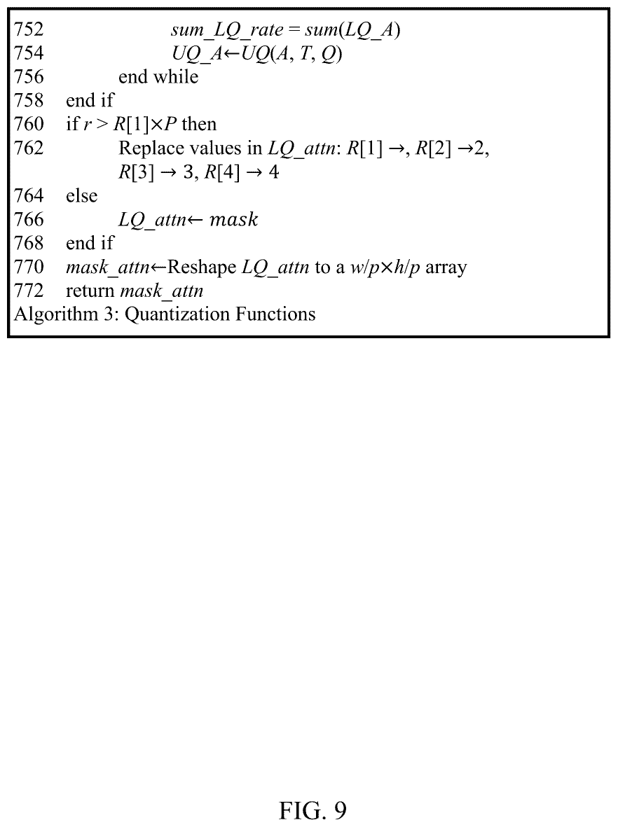

Referring to FIGS. 6-9, algorithms employed with embodiments of the present invention are depicted. FIGS. 6-7 includes lines 602-682 which illustrate pseudocode for training the adaptive multi-resolution encoding framework.

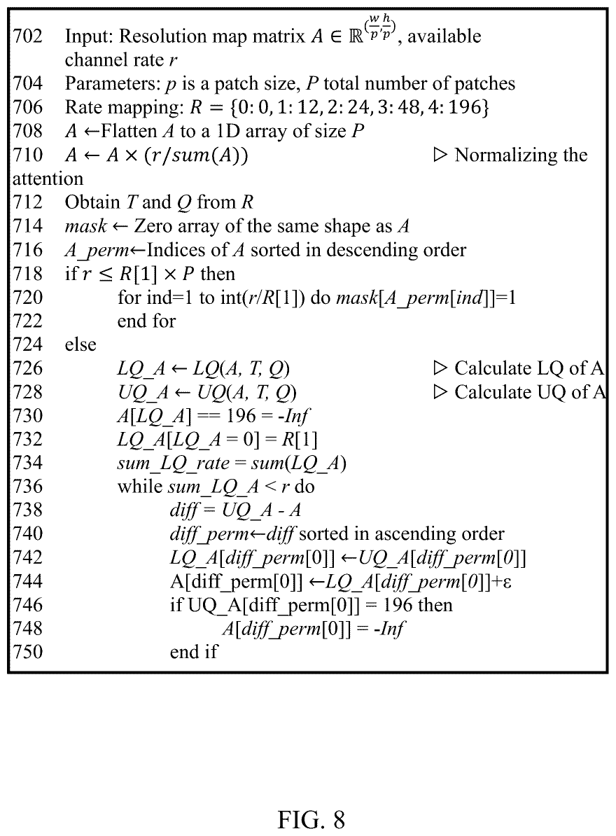

FIGS. 8-9 and 10 include lines 702-772 and lines 802-832, respectively, which illustrate pseudocode for attention-guided resolution selector 504 and accompanying helper algorithms for lower and upper quantization. A threshold resolution can be assigned by checking whether the channel rate r is sufficient to encode all patches at the lowest available resolution. If the channel rate is too low to encode all patches at this resolution, as many patches as possible are selected until the total bitrate meets the channel rate. If the channel rate exceeds the minimum required to encode all patches at the lowest resolution, resolution categories are assigned to each patch. The total sum of the attention scores for all patches is then determined.

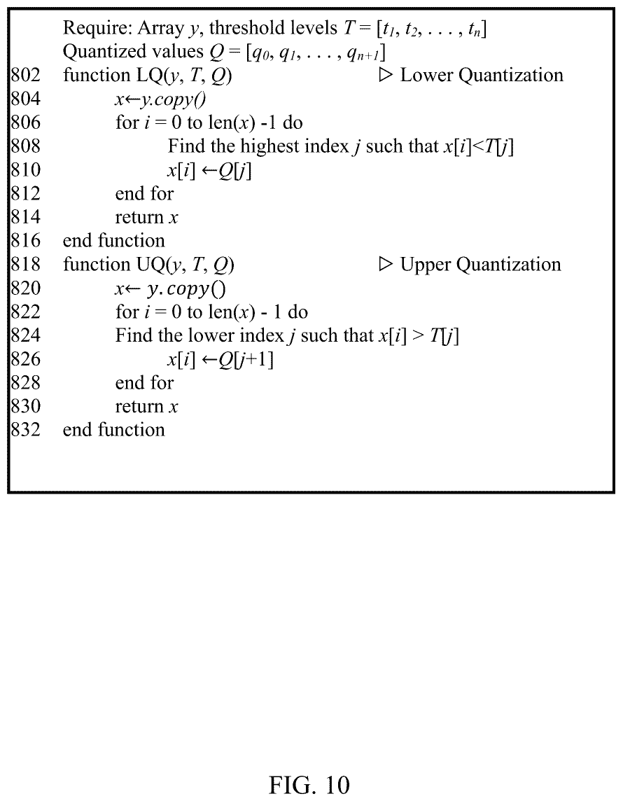

Then, each attention score is normalized by multiplying it by r divided the sum of attention scores. After normalization, function LQ (lower quantization) is applied (the function LQ is further elaborated on in FIG. 10) that maps the attention scores to their nearest lower resolution. The total encoding bitrate can be less than the available channel rate, meaning the channel is not fully utilized. To make use of the remaining bandwidth, another function UQ (upper quantization) can be applied (the function UQ is further elaborated on in FIG. 10), which maps the attention scores to the nearest higher resolution. The resolution of patches with attention scores that have the smallest gap to their UQ are “upgraded,” as these upgrades require the least additional bandwidth. This is repeated until the total encoding bitrate matches the channel rate.

The entries of the resolution map indicate the resolutions in which patches are encoded. The encoder-decoder pairs are trained for each of the resolutions. Each resolution is assigned an encoding size out of a set of possible quantized encoding sizes {bᵢ, 1≤i≤L}. The higher the resolution, the higher the assigned rate. For an encoding size bᵢ, the encoder takes an image patch Xⱼ, jϵ{1, 2, . . . , P} as an input and produces an embedding of size bᵢ and the decoder takes this embedding and produces \hat{X}ⱼ. The resolution map is designed to satisfy the available channel bitrate constraint and relies on error-free communication not exceeding the available bitrate. The encoder-decoder is trained for all resolutions according to: let \hat{X} denote the reconstructed image for all the patches \hat{X}ⱼ at the encoding sizes given by resolution map for the image X, the following loss function can be used for the training, [symbol] _{Encoder-Decoder}= [symbol] _{MSE}(X,\hat{X}).

The encoder-decoder pairs are trained independent of the analytic action function. In this case, the encoder-decoder pair is trained for each rate on all image patches available for training using the MSE loss function on individual patch Xⱼ, jϵ{1, 2, . . . , P} given by, [symbol] _{Encoder-Decoder}= [symbol] _{MSE}(X,\hat{X}).

The encoder-decoder pairs for different resolutions are trained independently. Hence, the encoder-decoder pairs do not need to be retrained when the semantic meaning or communication goal changes as imposed by different analytic action functions, e.g., the resolution selector retains the semantic meaning by properly incorporating the analytic action function in generation of the resolution map as the communication goal or task changes.

Embodiments of the present invention further fuse visual and textual modalities to enable semantically guided compression and transmission under bandwidth constraints. The encoder includes a multi-modal semantic extractor and a patch-wise multi-resolution encoder. The encoded image patches are transmitted and passed through resolution-specific decoders to reconstruct the final image. Alternative embodiments of the present invention include two inputs, an image and a user command. The goal of the multimodal semantic extractor is to fuse the vision and text inputs to produce a semantic core that indicates the most informative regions of an image given the user's textual query.

The semantic extractor model can build upon a Mask-Aware Fine Tuning (MAFT+) for open-vocabulary semantic segmentation (OSS). The image input xϵ [symbol] ^{3×h×w} is processed by a convolutional CLIP-Vision (CLIP-V) backbone to extract a feature pyramid F={F⁰, F¹, F², F³}, where Fⁱϵ [symbol] ^{d×h}^{ᵢ}^{×w}^{ᵢ} and the spatial strides relative to the input can be {4, 8, 16, 32} respectively, with a feature dimension d. Other embodiments of the present invention can exceed N⁴, for example the feature pyramid and corresponding spatial strides can be N⁵, N⁶, . . . N^{x}, etc. These visual features are processed by a MaskFormer™ proposal generator, which upsamples and fuses the multi-scale features into a dense per-pixel embedding map Eₚᵢₓₑₗϵ [symbol] ^{d×h×w}. Other proposal generators are also contemplated. A fixed set of N learnable query tokens

$${\{ {q}_{i} \}}_{i = 1}^{N}$$

is passed through a transformer decoder that performs cross-attention with Eₚᵢₓₑₗ, producing a set of mask embeddings

$${E}_{m a s k} = [ {E}_{m a s k}^{( i )} , … , {E}_{m a s k}^{( N )} ] ∈ {ℝ}^{N \times d} .$$

These embeddings are then projected back onto the spatial domain via dot product to compute the mask logits Mϵ [symbol] ^{N×h×w}, where each mask logit is given by:

$${m}_{i} ( h , w ) = {E}_{m a s k}^{( i ) T} {E}_{p ixel} [ : , h , w ] .$$

The resulting mask logits represent unbounded scores indicating the likelihood of each pixel belonging to each proposal. During training, a set of class prompts C indicating all possible objects is embedded via CLIP-Text (CLIP-T) encoder ƒₜ(⋅), producing text embeddings T=[tᵢ, . . . , t_{|C|}]ϵ [symbol] ^{d×|C|}. T is refined then via two transformer cross-attention layers called content-dependent transfer (CDT), attending on the flattened highest-level visual feature Tⱼ₊₁+Tⱼ+TransLayerⱼ(Tⱼ,

$${F}_{flat}^{3} )$$

for j=0, 1, with T₀=T. This yields a conditioned embedding \hat{T}ϵ [symbol] ^{d×|C|}. Meanwhile, mask pooling on F³ using each mask logit yields mask embeddings Vϵ [symbol] ^{N×d}. Per-mask classification scores are computed according to S_{cls}=(V\hat{T})^{T}ϵ [symbol] ^{|C|×N}. When projecting these scores onto the full image plane, dense semantic maps are formed of size |C|×h×w via

$$S ( c , h , w ) = {\sum }_{i = 1}^{N} {S}_{c l s} ( c , i ) \cdot σ ( {m}_{i} ( h , w ) ) ,$$

where σ is the sigmoid activation. The pixel-wise cross entropy is applied against ground-truth labels to train CDT and CLIP-V. Several losses can be used during training. First, the mask proposal loss Lₚ uses Hungarian matching between the predicted masks M and ground-truth masks, combining binary cross-entropy and Dice losses. This loss updates the MaskFormer proposal generator, keeping CLIP-V frozen. The mask-aware classification loss updates both the CDT layers and CLIP-V using ground-truth class labels

$${c}_{i}^{*}$$

where

$${ℒ}_{m a} = \frac{1}{\vert M \vert} {\sum }_{i ∈ m a t c h e d} - log \frac{exp ( {S}_{c l s} ( {c}_{i}^{*} , i ) )}{{\sum }_{c} exp {S}_{c l s} ( c , i )} .$$

Also, the representation compensation loss [symbol] _{rc} preserves original CLIP-V representation by matching multi-scale pooled features between the fine-tuned CLIP-V and a frozen CLIP-V* using SmoothL1 loss

$${ℒ}_{r c} = {\sum }_{k ∈ \{ 1 , 2 , 4 \}} SmoothL 1 ( {F}_{k}^{p} , {\hat{F}}_{k}^{p} ) .$$

Gradients from [symbol] ₘₐ and [symbol] _{rc} are backpropagated into CLIP-V (with [symbol] ₘₐ also updating CDT), while CLIP-T remains frozen throughout. At inference time the framework processes the text input as user command q through the frozen CLIP-T encoder ƒₜ(⋅) to produce tϵ [symbol] ^{d×1}. The generated text embedding t passes through the same refinement pipeline CDT to generate t which is a refined embedding of the text conditioned on the image features. Meanwhile, the image is passed through CLIP-V and MaskFormer to compute the visual features \hat{t}, mask logits M, and pooled mask embedding V. The pixel-level semantic relevance map is computed as

$${S}_{inf} ( h , w ) = {\sum }_{i = 1}^{N} 〈 \hat{t} , {v}_{i} 〉 \cdot σ ( {m}_{i} ( h , w ) ) .$$

This yields a relevance map S_{inf}ϵ [symbol] ^{l×h×w}, which encodes how well each pixel aligns with the user textual query. While the multi-modal semantic extractor is inspired by a generic Open-vocabulary Semantic Segmentation (OSS), there are differences between OSS and embodiments of the present invention. OSS produces binary segmentation masks indicating whether each object class is present. In contrast, embodiments of the present invention use a soft relevance score between 0 and 1, representing the confidence that a pixel corresponds to the queried concept. This soft score enables patch-wise variable-resolution encoding. Additionally, in OSS, the text input often consists of a list of single-word object categories, while in embodiments of the present invention, the user command is a single free-form query, potentially referencing multiple objects. An objective is to generate a mask that captures the degree to which each region of the image matches the intent of the query.

Given the relevance map S_{inf} and the available bandwidth budget B, the input image is first partitioned into P=(h/p)×(w/p) non-overlapping patches of size p×p. For each patch xᵢ, the semantic importance score sᵢ is computed by averaging the per-pixel values within the patch from S_{inf}. Each patch is then assigned to one of L predefined resolution levels, indexed by lᵢ ϵ{1, . . . , L}, where each level corresponds to a different encoding bitrate rₗ_{ᵢ}. Higher semantic scores are mapped to higher resolution levels (e.g., higher rₗ_{ᵢ}) to preserve useful information, while less relevant patches are compressed more aggressively to save bandwidth. The patch-to-resolution assignment is performed using a resource allocation described herein, ensuring that the total bitrate across all patches satisfies the constraint

$${\sum }_{i = 1}^{P} {r}_{{l}_{i}} \leq B .$$

Once the assignments are finalized, each patch xᵢ is encoded using its designated encoder εₗ_{ᵢ}(xᵢ), transmitted, and then decoded at the receiver via the corresponding decoder [symbol] ₗ_{ᵢ} to produce the reconstructed patch \hat{x}ᵢ. The final reconstructed image \hat{x}ϵ [symbol] ^{3×H×W} is assembled by placing all patches back into their original positions. Though in some embodiments of the present invention, the patches are not transmitted due to lack of relevance, in which case those patches are left blank or empty or extrapolated using available data from a model on the receiving side (e.g., using semantic data from patches 104 that have been transmitted). This framework enables task-driven, semantic-aware communication by strategically allocating communication resources based on the semantic relevance of image content with respect to the user's text query. As a result, semantically important regions, those most aligned with the user's intent, are preserved at higher fidelity, while less relevant regions are encoded more compactly, thus achieving efficient and goal-oriented transmission under bandwidth constraints.

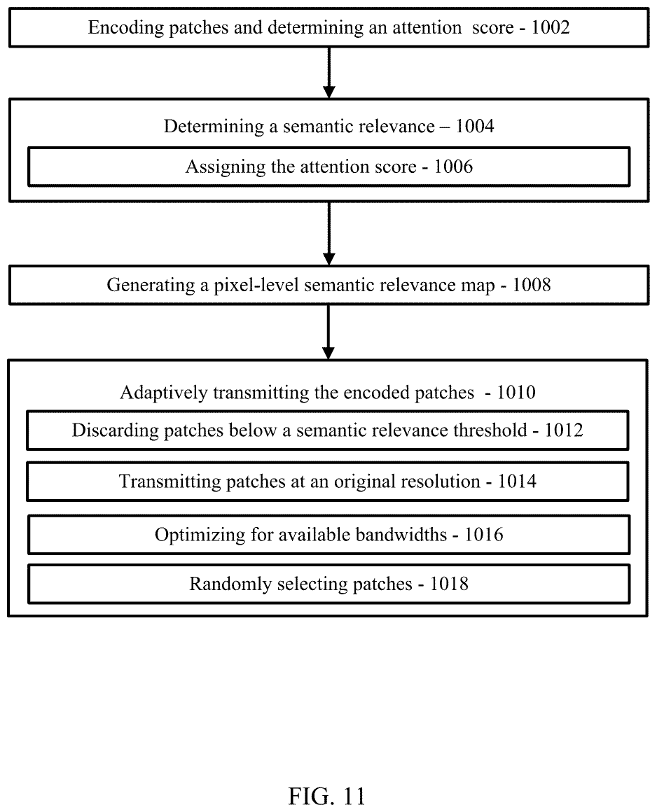

Referring to FIG. 11, a method for adaptive multi-resolution communication is depicted. In block 1002, patches of an image are encoded by flattening the patches to 1D vectors to form encoded patches and determining an attention score of each of the patches using a ViT. In block 1004, a semantic relevance of each of the patches to a user query is determined using the respective attention score. In block 1006, the attention score is assigned by averaging the attention score of each of the patches using a MHA in the ViT. In block 1008, a pixel-level semantic relevance map is generated to correlate the semantic relevance of each of the patches to the user query.

In block 1010, the encoded patches are adaptively transmitted with different resolutions based upon an amount of the semantic relevance. In block 1012, each of the patches with the semantic relevance below a semantic relevance threshold are discarded. In block 1014, each of the patches having semantic relevance above a semantic relevance threshold are transmitted at an original resolution. In block 1016, transmission is adapted to optimize for available bandwidths of a channel. In block 1018, patches are randomly selected below a semantic relevance threshold to be transmitted.

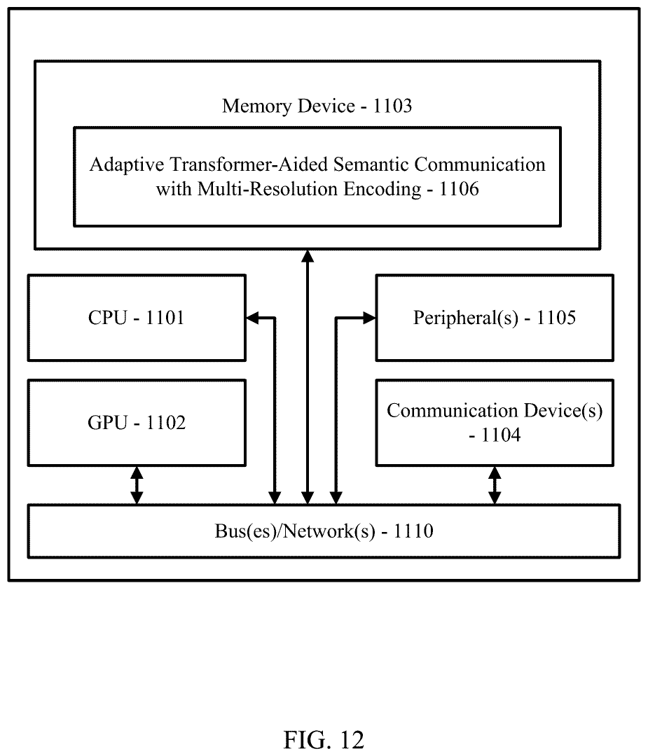

Referring to FIG. 12, a block diagram is shown for an exemplary processing system 1100, in accordance with an embodiment of the present invention. Processing system 1100 can adaptively transmit multi-resolution data. Processing system 1100 includes a set of processing units (e.g., CPUs) 1101, a set of GPUs 1102, a set of memory devices 1103, a set of communication devices 1104, and a set of peripherals 1105. CPUs 1101 can be single or multi-core CPUs. The GPUs 1102 can be single or multi-core GPUs. The one or more memory devices 1103 can include caches, RAMs, ROMs, and other memories (flash, optical, magnetic, etc.). The communication devices 1104 can include wireless and/or wired communication devices (e.g., network (e.g., Wi-Fi®, etc.) adapters, etc.). The peripherals 1105 can include a display device, a user input device, a printer, an imaging device, and so forth. Elements of processing system 1100 are connected by one or more buses or networks (collectively denoted by the figure reference numeral 1110).

In an embodiment of the present invention, memory devices 1103 can store specially programmed software modules to transform the computer processing system into a special purpose computer configured to implement various embodiments of the present invention. In an embodiment, special purpose hardware (e.g., Application Specific Integrated Circuits, Field Programmable Gate Arrays (FPGAs), and so forth) can be used to implement various embodiments of the present invention.

In an embodiment, memory devices 1103 store program code or software 1106 for adaptive transformer-aided communication with multi-resolution encoding. The generation and execution software 1106 includes encoding patches of an image by flattening the patches to 1D vectors to form encoded patches and determining an attention score of each of the patches using a ViT and determining a semantic relevance of each of the patches to a user query using the respective attention score. Software 1106 also includes adaptively transmitting the encoded patches with different resolutions based upon an amount of the semantic relevance.

Of course, the processing system 1100 may also include other elements (not shown), as readily contemplated by one of skill in the art, as well as omitting certain elements. For example, various other input devices and/or output devices can be included in processing system 1100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 1100 are readily contemplated by one of ordinary skill in the art given the teachings of the present invention provided herein.

Moreover, it is to be appreciated that various figures as described with respect to various elements and steps relating to the present invention that may be implemented, in whole or in part, by one or more of the elements of system 1100.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs). These and other variations of a hardware processor subsystem are also contemplated in accordance with embodiments of the present invention.

What is claimed is:

1. A method comprising:
encoding patches of an image by flattening the patches to one-dimensional (1D) vectors to form encoded patches and determining an attention score of each of the patches using a vision transformer (ViT);
determining a semantic relevance of each of the patches to a user query using the respective attention score; and
adaptively transmitting the encoded patches with different resolutions based upon an amount of the semantic relevance.

2. The method of claim 1, further comprising discarding each of the patches with the semantic relevance below a semantic relevance threshold.

3. The method of claim 1, wherein adaptively transmitting includes transmitting each of the patches having semantic relevance above a semantic relevance threshold at an original resolution.

4. The method of claim 1, wherein the encoding further comprises;
assigning the attention score by averaging the attention score of each of the patches using a multi-head attention (MHA) in the ViT.

5. The method of claim 1, wherein adaptively transmitting the encoded patches further comprises:
adapting transmission to optimize for available bandwidths of a channel.

6. The method of claim 1, further comprising:
generating a pixel-level semantic relevance map to correlate the semantic relevance of each of the patches to the user query.

7. The method of claim 1, wherein adaptively transmitting the encoded patches further comprises:
randomly selecting the patches below a semantic relevance threshold to transmit.

8. A system comprising:
a processor; and
a memory storing computer-readable instructions that, when executed by the processor, cause the system to:
encode patches of an image by flattening the patches to one-dimensional (1D) vectors to form encoded patches and determine an attention score of each of the patches using a vision transformer (ViT);
determine a semantic relevance of each of the patches to a user query using the respective attention score; and
adaptively transmit the encoded patches with different resolutions based upon an amount of the semantic relevance.

9. The system of claim 8, wherein the memory further causes the system to discard the patches with the semantic relevance below a semantic relevance threshold.

10. The system of claim 8, wherein the memory further causes the system to transmit each of the patches having semantic relevance above a semantic relevance threshold at an original resolution.

11. The system of claim 8, wherein when the system encodes the patches, the memory further causes the system to;
assign the attention score by averaging the attention score of each of the patches using a multi-head attention (MHA) in the ViT.

12. The system of claim 8, wherein when the system adaptively transmits the encoded patches, the memory further causes the system to:
adapt transmission to optimize for available bandwidths of a channel.

13. The system of claim 8, wherein the memory further causes the system to:
generate a pixel-level semantic relevance map to correlate the semantic relevance of each of the patches to the user query.

14. The system of claim 8, wherein when the system adaptively transmits the encoded patches, the memory further causes the system to:
randomly select the patches below a threshold to transmit.

15. A computer program product comprising a non-transitory computer-readable storage medium containing computer program code, the computer program code when executed by one or more processors causes the one or more processors to perform operations, the computer program code comprising instructions to:
encode patches of an image by flattening the patches to one-dimensional (1D) vectors to form encoded patches and determine an attention score of each of the patches using a vision transformer (ViT);
determine a semantic relevance of each of the patches to a user query using the respective attention score; and
adaptively transmit the encoded patches with different resolutions based upon an amount of the semantic relevance.

16. The computer program product of claim 15, wherein the computer program code further includes instructions to discard the patches with the semantic relevance below a semantic relevance threshold.

17. The computer program product of claim 15, wherein the computer program code further includes instructions to transmit each of the patches having semantic relevance above a semantic relevance threshold at an original resolution.

18. The computer program product of claim 15, wherein when the computer program product encodes the patches, the one or more processors;
assign the attention score by averaging the attention score of each of the patches using a multi-head attention (MHA) in the ViT.

19. The computer program product of claim 15, wherein when the computer program product adaptively transmits the encoded patches, the one or more processors:
adapt transmission to optimize for available bandwidths of a channel.

20. The computer program product of claim 15, wherein the computer program code further causes the one or more processors to:
generate a pixel-level semantic relevance map to correlate the semantic relevance of each of the patches to the user query.
